(19) United States
(12) Patent Application Publication
(10) Pub. No.: US 2002/0018744 A1
(43) Pub. Date: Feb. 14, 2002

(54) Continuous preparation of hydrocyanic acid by thermolysis of formamide

(76) Inventors: Wolfgang Mattmann, Limburgerhof (DE); Walter Lenz, Schwetzingen (DE); Helmuth Menig, Friedelsheim (DE); Wolfgang Siegel, Limburgerhof (DE)

Correspondence Address: Messrs. Keil & Weinkauf, 1101 Connecticut Ave., N.W., Washington, DC, 20036, US

(21) Appl. No.: 09/734,027

(22) Filed: Dec. 12, 2000

(30) Foreign Application Priority Data
Dec. 22, 1999 (DE) 19962418.6

(51) Int. Cl. C01C 3/02

(52) U.S. Cl. 423/373

(57) ABSTRACT

In a continuous process for preparing hydrocyanic acid by thermolysis of gaseous, superheated formamide at elevated temperature and reduced pressure in the presence of a finely divided solid catalyst in a thermolysis reactor, the solid catalyst is kept in motion by upward-directed or downward-directed vertical flow of the gaseous reaction mixture.

The invention relates to a continuous process for preparing hydrocyanic acid by thermolysis of formamide in the presence of a solid catalyst.

In known industrial processes, for example corresponding to EP-A-0 209 039, hydrocyanic acid is prepared by thermolytic dissociation of formamide in shelland-tube reactors. According to EP-A-0 209 039, liquid formamide is vaporized, superheated and introduced at from 300 to 480° C. and a pressure of from 100 to 350 mbar together with from 0.1 to 10% by volume of air into the tubes of the shell-and-tube reactor, which are filled with highly sintered shaped catalyst bodies of aluminum oxide and silicon dioxide. The reaction takes place at from 450 to 590° C. and residence times of less than 0.25 seconds. Under such reaction conditions, it is inevitable that the catalyst activity will decrease with time and that the reactor will have to be shut down at intervals so that the catalyst can be regenerated. In the known process, with the reaction mixture being passed over the shaped catalyst bodies located in the tubes of the shell-and-tube reactor, a constant temperature profile can be achieved neither across the entire reactor cross section nor over the length of the reaction tubes, resulting in carbon deposits being formed to different degrees in the individual tubes and the differences increasing with time as the reaction progresses, thus leading to decreasing selectivity of the reaction.

It is an object of the present invention to provide a process which has improved economics and has lower capital costs, an increased plant availability due to the regeneration phase being dispensed with, an increased space-time yield and better and more uniform catalyst utilization with the consequence of a further increase in selectivity.

The achievement of this object starts out from a continuous process for preparing hydrocyanic acid by thermolysis of gaseous formamide in the presence of a finely divided solid catalyst in a thermolysis reactor.

In the process of the present invention, the solid catalyst is kept in motion by upward-directed or downward-directed vertical flow of the gaseous reaction mixture.

In the present process, the thermolysis of formamide is, as is customary in industrial processes, carried out at from 400 to 800° C. and absolute pressures of from 100 mbar to 1 bar. As regards the solid catalysts which can be used, there are likewise no fundamental restrictions. Preference is given to using aluminum oxide or aluminum oxide/silicon dioxide. The solid catalyst used in the present process is finely divided, i.e. the particle sizes determined by means of sieve analysis in accordance with DIN 4193 are in the range from 0 to 1000 μm, preferably from 0 to 200 μm. The starting material formamide is, as is generally customary in the thermolysis to form hydrocyanic acid, introduced into the thermolysis reactor at the abovementioned temperatures and pressures.

As thermolysis reactor, it is in principle possible to use any reactor which is designed for the abovementioned temperature and pressure ranges. The thermolysis reactor has an inlet for the gaseous reaction mixture at one end and an outlet for the gaseous reaction mixture at the opposite end. The finely divided solid catalyst may be located on an inflow plate located in the lower region of the reactor above the inlet for the reaction mixture. According to the present invention, the finely divided solid catalyst is kept in motion by upward-directed or downward-directed vertical flow of the gaseous reaction mixture, i.e. the individual particles of the solid catalyst continually change their position relative to one another and also their position in the reactor. There is therefore an upward-directed or downward-directed vertical flow of gas and solid in the reactor, i.e. solid particles move in the same direction as the gas.

It is known from flow dynamics that the flow state in such systems depends on the solid particles used, in particular their size, the type of gas and the gas velocity employed. At low gas velocities, the solid layer located on the inflow plate is at rest; it is present as a fixed bed. If the gas velocity is increased, the solid particles begin to move relative to one another above the minimum fluidization velocity; the flow state is referred to as a fluidized bed. When the gas velocity is increased further, discharge of solid occurs above the individual particle settling velocity of the smallest solid particles. The fluidized bed can only be operated in a steady state when the discharged solid is precipitated in a cyclone and returned to the fluidized bed or when an amount of solid equal to the amount discharged is continually fed into the fluidized bed. The flow state is referred to as a circulating fluidized bed.

A further increase in the gas velocity results in a flow state in which there is no gradient in the solids concentration over the height of the apparatus outside the acceleration region of the solid particles immediately above the inflow plate. At these gas velocities, an inflow plate is no longer absolutely necessary. The flow state is referred to as pneumatic transport, and the corresponding apparatus is referred to as a fly dust reactor or transport reactor.

In the process of the present invention, the solid catalyst is kept in motion, i.e. the flow state of a fluidized bed, a circulating fluidized bed or pneumatic transport is realized. The flow velocities of the gaseous reaction mixture to be set so as to achieve this can be determined by a person skilled in the art of flow dynamics on the basis of the specific process parameters. The gaseous reaction mixture is preferably passed through the reactor at an empty tube velocity of from 0.2 m/s to 30 m/s, particularly preferably from 8 m/s to 20 m/s.

In one embodiment, the thermolysis reactor is operated as a fluidized-bed reactor. For this purpose, the velocity of the gaseous reaction mixture is set in the range between the minimum fluidization velocity and the individual particle settling velocity.

A further preferred embodiment provides for the thermolysis to be carried out in a circulating fluidized bed. For this purpose, the velocity of the gaseous reaction mixture is set to a value above the individual particle settling velocity and below the velocity which leads to pneumatic transport.

In a further preferred variant, the thermolysis is carried out in a fly dust reactor. For this purpose, the velocity of the gaseous reaction mixture is set so as to achieve the flow state of pneumatic transport.

In an embodiment of the process of the present invention, the gas/solids mixture flows through the thermolysis reactor from the top downward. Such a thermolysis reactor is referred to as a downer. This variant has the additional advantage that gas throughput and solids throughput can be set independently.

The elevated temperature necessary for the endothermic reaction can, in one embodiment, be achieved by indirect introduction of energy. For this purpose, heat exchange tubes through which a heat transfer medium flows are preferably installed in the thermolysis reactor. It is in principle possible to use any suitable heat transfer medium.

However, it is particularly useful to provide, in addition to or as an alternative to indirect introduction of energy, a direct energy input. This can advantageously be achieved by firstly heating the finely divided solid catalyst by means of flue gas, subsequently separating it off from the flue gas, in particular in a cyclone, and finally introducing it into the thermolysis reactor. The term flue gases refers to combustion gases of any fuel.

In a further preferred embodiment, direct energy input can be achieved by means of superheated steam, i.e. steam having a temperature in the range from about 400 to 800° C., which is introduced directly into the thermolysis reactor. This process variant has the additional advantage that the partial pressure requirement of from 100 to 350 mbar customary for the reaction can be achieved while at the same time allowing the process to be operated at a total pressure in the region of atmospheric pressure. As a result, the apparatus requirements associated with operation under subatmospheric pressure are reduced.

The geometric configuration of the thermolysis reactor is not subject to any restrictions in principle. However, particular preference is given to a reactor comprising an upright cylinder having a diameter in the range from 0.1 to 12 m, in particular from 3 to 6 m, particularly preferably 4 m, and a height in the range from 8 to 35 m, in particular from 20 to 30 m, particularly preferably 30 m.

The example below illustrates the invention.

A gaseous reaction mixture comprising formamide at 160° C. corresponding to a pressure of 170 mbar together with 3% by volume of air was fed into a cylindrical reactor which had a diameter of 4 m and a height of 30 m and in whose lower region highly sintered aluminum oxide catalyst particles having an average particle size of 50 μm were located on an inflow plate. The process pressure was 150 mbar, the empty tube velocity of the gaseous reaction mixture was 20 m/s and the mean gas residence time was 1.5 sec. The flow state of a circulating fluidized bed was established in the thermolysis reactor. The capital costs of the thermolysis reactor were only one third of the costs of a conventional shell-and-tube reactor with the same formamide throughput. The unit did not have to be shut down for regeneration purposes. In contrast to known processes, which require at least two thermolysis reactors for continuous operation due to the need for catalyst regeneration, the process of the present invention requires only a single thermolysis reactor for continuous preparation of hydrocyanic acid.

In the process of the present invention, use is made of a finely divided catalyst. It is a general rule that the specific surface area increases with decreasing particle diameter. Thus, for example, the same amount of catalyst material which is converted into cubes having an edge length of 10 μm has 1000 times the surface area of a material in the form of cubes having an edge length of 1 cm. The utilization of the expensive catalyst material is correspondingly better.

The finely divided catalyst used according to the present invention has the further advantage over the shaped catalyst bodies used in the known process that it is not susceptible to mechanical damage.

Due to the gaseous reaction mixture being kept in motion according to the present invention, better heat input and improved mass transfer are achieved, with the consequence of a largely uniform temperature over the entire thermolysis reactor and thus an improvement in the selectivity of the reaction. In contrast, a temperature profile is always established over the length of the fixed-bed tubes in the known industrial process, resulting in nonuniform catalyst utilization and a drop in the selectivity.

The process of the present invention has the further advantage that it is not tied to the use of a salt melt as heat transfer medium. Conventional industrial shell-andtube apparatuses for the thermolysis of formamide are heated by means of salt melts as heat transfer medium in order to ensure an at least substantially isothermal temperature profile over the reactor cross section. An acceptable uniformity of the temperature distribution can no longer be achieved using flue gas as heat transfer medium. However, the maximum temperature is restricted to about 550° C. in practical terms when using salt melts. However, the process of the present invention is not subject to such a restriction in respect of the heat transfer medium and thus the temperature.

The maximum capacity of known industrial plants is limited by engineering considerations, in particular the dimensions and the stability of the tube plates between which the tubes of the tube bundle are fitted, and also by the achievable temperature uniformity. In contrast, the plant capacity is not subject to such restrictions when using the process of the present invention.

We claim:

1. A continuous process for preparing hydrocyanic acid by thermolysis of gaseous formamide in the presence of a finely divided solid catalyst in a thermolysis reactor, wherein the solid catalyst is kept in motion by upward-directed or downward-directed vertical flow of the gaseous reaction mixture.

2. A process as claimed in claim 1, wherein the thermolysis reactor is a fluidized-bed reactor.

3. A process as claimed in claim 2, wherein the thermolysis reactor is a fluidized-bed reactor having a circulating fluidized bed.

4. A process as claimed in claim 1, wherein the thermolysis reactor is a fly dust reactor.

5. A process as claimed in claim 1, wherein the thermolysis reactor is a downer.

6. A process as claimed in claim 1, wherein the elevated temperature for the thermolysis is achieved by indirect introduction of energy.

7. A process as claimed in claim 6, wherein the introduction of energy is carried out via heat exchange tubes through which a heat transfer medium flows installed in the thermolysis reactor.

8. A process as claimed in claim 1, wherein energy is introduced directly by firstly heating the solid catalyst by means of flue gas, subsequently separating it off from the flue gas, in particular in a cyclone, and finally introducing it into the thermolysis reactor.

9. A process as claimed in claim 1, wherein energy is introduced directly by means of superheated steam which is introduced directly into the thermolysis reactor.

10. A process as claimed in claim 1, wherein the thermolysis reactor is configured as an upright cylinder having a diameter in the range from 0.1 to 12 m, in particular from 3 to 6 m, particularly preferably 4 m, and a height in the range from 8 to 35 m, in particular from 20 to 30 m, particularly preferably 30 m.

11. A process as claimed in claim 1, wherein the gaseous reaction mixture is passed through the thermolysis reactor at an empty tube velocity in the range from 0.2 to 30 m/s, preferably from 8 to 20 m/s.
